(19) United States
(12) Patent Application Publication
(10) Pub. No.: US 2015/0153290 A1
(43) Pub. Date: Jun. 4, 2015

(54) X-RAY APPARATUS AND METHOD OF MEASURING X-RAYS

(71) Applicant: CANON KABUSHIKI KAISHA, Tokyo (JP)

(72) Inventor: Taihei Mukaide, Yokohama-shi (JP)

(73) Assignee: CANON KABUSHIKI KAISHA, Tokyo (JP)

(21) Appl. No.: 14/405,764

(22) PCT Filed: May 21, 2013
(86) PCT No.: PCT/JP2013/064567

§ 371 Date: Dec. 4, 2014

(30) Foreign Application Priority Data
Jun. 7, 2012 (JP) 2012-130102

(51) Int. Cl. G01N 23/083; G01T 1/29

(52) U.S. Cl. CPC G01N 23/083; G01T 1/2928

(57) ABSTRACT

An X-ray apparatus and an X-ray measuring method which are capable of obtaining object information including information about scattering of X-rays by an object are provided. The X-ray apparatus includes a detector configured to detect an intensity of an X-ray beam passed through an object. The detector includes a first pixel and a second pixel different from the first pixel. The apparatus is configured such that when the object is not disposed in an optical path of the X-ray beam, the center of an intensity distribution of the X-ray beam applied to the detector does not coincide with a boundary between the first and second pixels.

### TECHNICAL FIELD

The present invention relates to an X-ray apparatus using X-rays and a method of measuring X-rays.

### BACKGROUND ART

Nondestructive inspection using radiation has been used in a wide range of applications from industrial to medical applications. For example, X-rays, a kind of radiation, are electromagnetic waves having a wavelength in the range of approximately 10⁻¹² to approximately 10⁻⁸ m. X-rays with higher energies (approximately 2 keV to approximately 100 keV) are called hard X-rays. X-rays with lower energies (approximately 0.1 keV to approximately 2 keV) are called soft X-rays.

Absorption contrast imaging using differences in x-ray absorption power has been in practical use for internal crack inspection of, for example, steel materials and security applications, such as baggage inspection.

X-ray phase contrast imaging for detecting a change in phase of X-rays caused by an object is effective in objects (e.g., low-density objects) in which contrast is hardly generated from X-ray absorption. Such X-ray phase contrast imaging is being examined for applications in, for example, imaging of a phase-separated structure of polymeric materials and medical field.

PTL 1 discloses X-ray phase contrast imaging in which spatially separated X-rays are allowed to enter an object and the angles of refractions of passed X-rays are determined.

FIG. 9 illustrates, in outline, an apparatus disclosed in PTL 1. X-rays emitted from an X-ray source 901 are spatially separated into a plurality of X-ray beams by a splitting element 902. The spatially separated X-ray beams pass through an object 903 and then impinge on an X-ray detector 904.

FIG. 10 schematically illustrates the X-ray detector 904. The X-ray detector 904 includes a plurality of pixels 1001. For example, reference X-ray beams 1002 separated by the splitting element 902 (X-ray beams applied while the object 903 is not disposed in an optical path) are applied in a discrete pattern in X and Y directions such that each of areas irradiated with the X-ray beams includes four pixels.

The X-ray detector 904 detects an intensity of each X-ray beam in each of the pixels irradiated with the X-ray beam. An X-ray beam 1003 is an X-ray beam refracted by passing through the object 903. The effect of refraction causes the position of the X-ray beam 1003 incident on the X-ray detector 904 to be changed relative to the corresponding reference X-ray beam 1002. Furthermore, an absorption effect causes the X-ray beam 1003 to have a lower integrated intensity than the reference X-ray beam 1002.

An X-ray transmittance of the object 903 can be obtained using the sum of detected intensities of X-rays in the pixels irradiated with the X-ray beam 1003 and the sum of detected intensities of X-rays in the pixels irradiated with the corresponding reference X-ray beam 1002. Changes in X-ray intensity (or X-ray transmittance) are used to form an image, thereby obtaining an absorption-contrast image of the object 903.

In addition, a position variation ΔX and a position variation ΔY in the X and Y directions can be obtained by comparing the center of intensity of the X-ray beam 1003 (the center of gravity of the X-ray beam) with that of the corresponding reference X-ray beam 1002. The position variations of the center of gravity of the X-ray beam are caused by a phase change of X-rays by the object 903. Phase information about the object 903 is therefore obtained from the position variations of the center of gravity of the X-ray beam. An image is formed on the basis of the information, thus obtaining a phase-contrast image of the object 903.

If the object 903 is an aggregate of fine particles or the like, the X-ray beam 1003 spreads by scattering as compared with the corresponding reference X-ray beam 1002. This spread is due to scattering of X-rays by the object 903. The degree of scattering of X-rays by the object 903 is obtained on the basis of the degree of spread. An image is formed on the basis of the obtained degree of scattering, thus obtaining a scattering-contrast image of the object 903.

FIGS. 11A and 11B are diagrams explaining the above-described absorption-contrast image, phase-contrast image, and scattering-contrast image from another point of view. FIG. 11A illustrates a reference X-ray beam 1102 and an X-ray beam 1103 on a detector 1101. The reference X-ray beam 1102 does not pass through an object and the X-ray beam 1103 has passed through the object. Since X-rays are absorbed and refracted by the object, the X-ray beam 1103 has a lower intensity than the reference X-ray beam 1102. Furthermore, the position of the X-ray beam 1103 is different from that of the reference X-ray beam 1102. An absorption-contrast image and a phase-contrast image are obtained on the basis of variations in intensity and position.

FIG. 11B illustrates an example of scattering of the X-ray beam 1103 in FIG. 11A by the object. An X-ray beam 1104 has a wider width than the X-ray beam 1103. A scattering-contrast image is obtained on the basis of variations in intensity distribution of X-rays.

In the technique disclosed in PTL 1, many pixels are used to obtain information about scattering of X-rays by an object and a scattering-contrast image is obtained on the basis of the information. Accordingly, accurate detection of spread due to scattering requires a detector having pixels which are sufficiently small relative to the spread of the reference X-ray beam 1102. It is typically difficult to increase the field of view of a detector having small pixels. Disadvantageously, it is difficult for such a detector having small pixels to deal with a large object. Furthermore, as the pixel size is smaller, the sensitivity to X-rays of each pixel is typically lower. Accordingly, the amount of X-rays applied to an object tends to be increased in order to obtain a high-quality image.

### CITATION LIST

### Patent Literature

PTL 1 U.S. Pat. No. 5,802,137

### SUMMARY OF INVENTION

The present invention provides an X-ray apparatus and an X-ray measuring method which are capable of obtaining object information including information about scattering of X-rays by an object in the use of a technique different from that disclosed in PTL 1. An image including scattering-contrast information can be formed by imaging the object information obtained according to the present invention.

An aspect of the present invention provides an X-ray apparatus including a detector configured to detect an intensity of at least one X-ray beam passed through an object. The detector has a first pixel and a second pixel different from the first pixel. The apparatus is configured such that when the object is not disposed in an optical path of the X-ray beam, the center of an intensity distribution of the X-ray beam applied to the detector does not coincide with a boundary between the first and second pixels.

Other features of the present invention will be described in the following embodiments.

### BRIEF DESCRIPTION OF DRAWINGS

FIG. 1 is a diagram explaining a configuration of an apparatus according to a first embodiment.

FIG. 2 is a diagram explaining a change in intensity profile of an X-ray beam.

FIGS. 3A and 3B are diagrams explaining a relationship between the X-ray beam and pixels in the first embodiment.

FIGS. 4A and 4B are diagrams explaining a Δx versus v relationship.

FIGS. 5A and 5B are diagrams explaining the Δx versus v relationship.

FIG. 6 is a diagram explaining a configuration of an apparatus according to a second embodiment.

FIG. 7 is a diagram explaining the relationship between X-ray beams and pixels in the second embodiment.

FIGS. 8A to 8D are diagrams illustrating experimental results described in an example.

FIG. 9 is a diagram illustrating, in outline, a configuration of an apparatus related to a technique disclosed in PTL 1.

FIG. 10 is a diagram illustrating, in outline, a detector in PTL 1.

FIGS. 11A and 11B are diagrams explaining changes of X-ray beams caused by absorption, phase, and scattering.

FIGS. 12A and 12B are diagrams explaining the relationships described with reference to FIGS. 5A and 5B from another point of view.

FIGS. 13A and 13B are diagrams explaining the relationships described with reference to FIGS. 5A and 5B from another point of view.

### DESCRIPTION OF EMBODIMENTS

According to an embodiment of the present invention, an X-ray apparatus includes a detector and uses at least one X-ray beam to obtain results of detection from which information items about phase change, scattering, and absorption of X-rays by an object can be obtained. The X-ray apparatus according to the embodiment further includes an arithmetic unit and, accordingly, can obtain phase change information (hereinafter, also simply referred to as “phase information”), scattering information, and absorption information about X-rays passed through the object from the results of detection by the detector. In the embodiment, the phase information and the scattering information are not separated. Information including the phase information and the scattering information is obtained and the absorption information is further obtained.

The apparatus is configured such that the X-ray beam is applied so as to span at least two pixels of the detector. The detector is disposed such that when an object is not disposed in an optical path of the X-ray beam, the center of the intensity distribution is offset from a boundary between a first pixel and a second pixel. The arithmetic unit obtains object information including phase information and scattering information from information about intensities in the first and second pixels. An image including a phase contrast and a scattering contrast can be formed by imaging the obtained information. Furthermore, the arithmetic unit is configured to be capable of obtaining an absorption-contrast image. Preferred embodiments will be described below. Note that the center of the intensity distribution of the X-ray beam is obtained by replacing “mass” of the center of mass with “intensity” and means the center of gravity of the X-ray beam.

### First Embodiment

A first embodiment relates to an X-ray apparatus and a method of measuring X-rays, the apparatus and method using a single X-ray beam.

### Basic Configuration of Apparatus

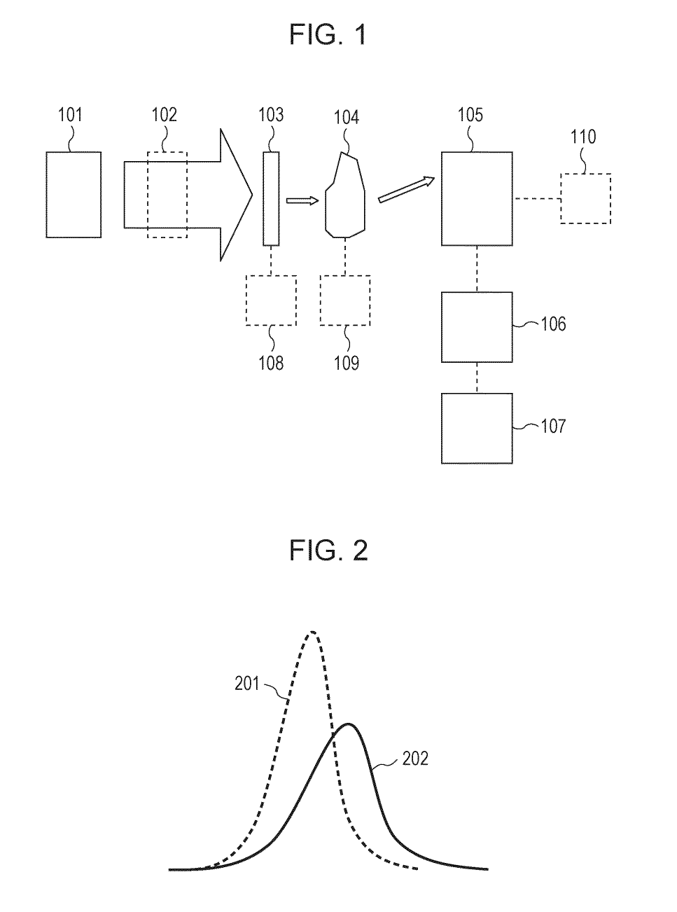

FIG. 1 is a diagram illustrating a configuration of the X-ray apparatus according to the first embodiment.

X-rays emitted from an X-ray source 101, serving as an X-ray generator, pass through an aperture of an aperture plate 103, thus forming an X-ray beam.

Examples of the aperture of the aperture plate 103 may include a slit through which an X-ray beam having a line-shaped cross-section can be formed and a pinhole through which an X-ray beam having a point-like cross-section can be formed. Such a slit or pinhole may extend through the aperture plate 103 or does not necessarily have to extend therethrough. If the slit or pinhole does not extend through the aperture plate 103, a filter material for X-rays may be used for the aperture plate 103. A material for the aperture plate 103 may be selected from, for example, Pt, Au, Pb, Ta, and W which exhibit high X-ray absorptance. Alternatively, the material for the aperture plate 103 may be a compound containing these materials.

FIG. 2 schematically illustrates an intensity profile of an X-ray beam passed through an object 104. An X-ray beam 201 has an intensity profile obtained while the object 104 is not disposed in the optical path of the X-ray beam. An X-ray beam 202 has an intensity profile obtained while the object 104 is disposed in the optical path of the X-ray beam. The object 104 absorbs X-rays, so that the intensity of the X-ray beam decreases. Furthermore, the object 104 changes the phase of X-rays and refracts the X-rays, so that the position of the X-ray beam is shifted. In addition, the intensity profile of the X-ray beam is broadened by scattering of X-rays by the object 104.

The X-ray beam passed through the object 104 is applied to a detector 105 which obtains intensities of X-rays. Information about the intensities of X-rays obtained by the detector 105 is subjected to arithmetic operation by an arithmetic unit 106. The resultant data is output to a display unit 107, such as a monitor.

Examples of the object 104 include a human body, an inorganic material, and an inorganic and organic composite material.

Moving units, such as stepping motors, 108, 109, and 110 configured to move the aperture plate 103, the object 104, and the detector 105 relative to one another, respectively, may be provided. For example, measurement is performed while the object 104 is being moved by the moving unit 109, so that an image of the whole of the object 104 can be obtained.

As regards the detector 105, any of various two-dimensional X-ray detectors may be used regardless of an indirect conversion type or a direct conversion type. The detector 105 may be selected from, for example, an X-ray CCD camera, an indirect conversion flat panel detector, and a direct conversion flat panel detector. Alternatively, a separate photodiode may be used.

If monochromatic X-rays are used, a monochromatizing unit 102 may be disposed between the X-ray source 101 and the aperture plate 103. Examples of the monochromatizing unit 102 include a monochromator with slits and an X-ray multilayer mirror.

Position Variation Vs. Contrast Relationship

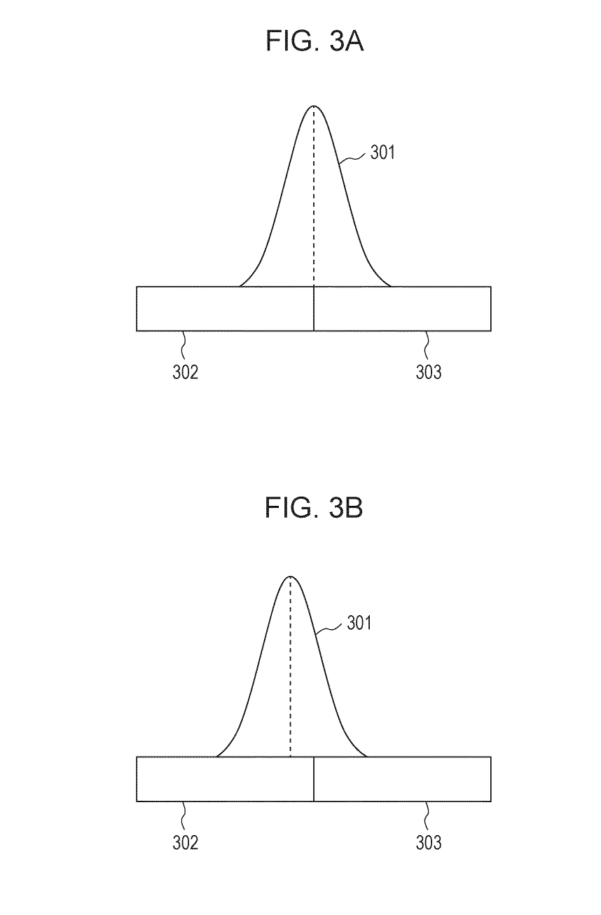

A relationship between the X-ray beam and the detector 105 in this embodiment will be described with reference to FIGS. 3A and 3B. Referring to FIGS. 3A and 3B, an X-ray beam intensity profile (intensity distribution) 301 is obtained while the object 104 is not disposed in the optical path of the X-ray beam and demonstrates that as the peak is higher (upward in FIGS. 3A and 3B), the X-ray intensity is higher. The detector 105 has a first pixel 302 and a second pixel 303 different from the first pixel 302. The position of the center of the intensity profile relative to a boundary between the first pixel 302 and the second pixel 303 in FIG. 3A differs from that in FIG. 3B.

Although the first pixel 302 is disposed next to the second pixel 303 in FIGS. 3A and 3B, the first pixel 302 and the second pixel 303 are determined depending on an area to be used for arithmetic operation. For example, four pixels out of eight pixels can be set to the first pixel 302 and the remaining four pixels can be set to the second pixel 303.

Since the X-ray beam is refracted by passing through the object 104 as described above with reference to FIG. 2, the position of the X-ray beam is shifted on the detector 105. A position variation of the X-ray beam can be estimated on the basis of an indicator that enables determination of the difference in variation between a detected intensity in the first pixel 302 and a detected intensity in the second pixel 303.

For example, the position variation can be estimated using a value v given by Expression (1) where I₁ denotes the intensity in the first pixel 302 and I₂ denotes the intensity in the second pixel 303.

$$\begin{matrix}[ Math . 1 ] & \\ v = \frac{{I}_{1} - {I}_{2}}{{I}_{1} + {I}_{2}} & ( 1 )\end{matrix}$$

To eliminate the effect of absorption, the difference between the intensities I₁ and I₂ is divided by the sum of the intensities I₁ and I₂.

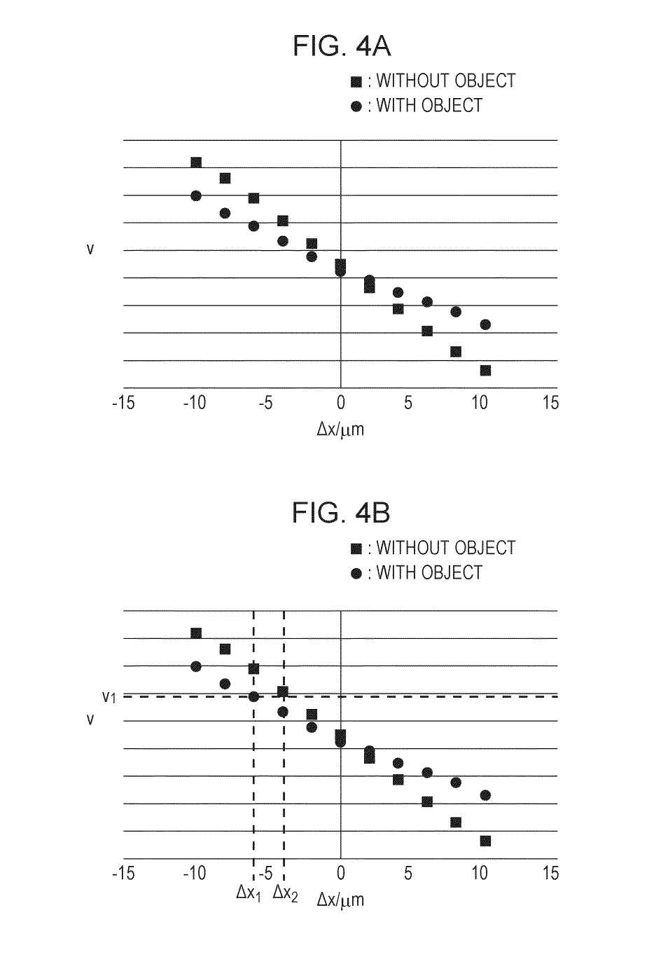

FIG. 4A illustrates a relationship between the position variation (Δx) of the center of gravity of the X-ray beam and the value v in the case where the center of the intensity profile coincides with the boundary between the first pixel 302 and the second pixel 303 (refer to FIG. 3A). Hereinafter, the position variation of the center of gravity of the X-ray beam will also be simply called a “position variation of the X-ray beam”.

In FIG. 4A, a plot of solid squares represents a data set obtained by moving the X-ray beam relative to the detector 105 while an object (known sample) was not disposed in the optical path and a plot of solid circles represents a data set obtained in that manner while the object was disposed in the optical path. Specifically, the plot of solid squares merely represents the relationship between the position of the X-ray beam and the value v and the plot of solid circles represents the relationship between the intensity profile of the X-ray beam refracted and scattered by the object and the value v.

As will be understood from FIG. 4A, these plots each represent a substantially linear relationship. The slope of the data set obtained with the object is smaller than that of the data set obtained without the object. In these data sets, the data items have values v slightly different from each other at the same value Δx. Accordingly, an image including phase contrast information and scattering contrast information can be obtained.

More specific description will be made with reference to FIG. 4B. If the value Δx affected by the object (known sample) which causes scattering is Δx₁, it should be that v=v₁.

Actual data will be obtained from an unknown sample. Accordingly, if the value v=v₁ is obtained as a result of experiment on an unknown sample, the value can be substituted only into a relational expression (a plot indicated by solid squares) derived from the data set obtained while the object (sample) was not disposed. In the plot (indicated by the solid squares) of the data set obtained while the object was not disposed in the optical path, when v=v₁, Δx=Δx₂.

Specifically, although a true position variation (Δx) of an X-ray beam passed through a certain area is Δx₁, the position variation is Δx₂ because the position variation of the X-ray beam is determined using data obtained without the object. In imaging position variations, the difference between the true position variation (Δx₁) and the obtained position variation (Δx₂ in this case) causes a contrast in a first area with scattering to be smaller at all times than a contrast in a second area with no scattering on condition that the amount of refraction of the X-ray beam in the first area is the same as that in the second area.

Since the position variation of the X-ray beam caused by the phase change of the X-ray beam is very small, a difference hardly occurs between the data set obtained with the object and the data set obtained without the object in FIGS. 4A and 4B, so that it is difficult to form a contrast. If there is little refraction of the X-ray beam passed through the object, the data obtained with the object has substantially the same value v (see values at or around Δx=0 in FIGS. 4A and 4B) as that of the data obtained without the object. Accordingly, if the value Δx is obtained from the value v, the effect of scattering by the object on the obtained value Δx is small. If the value Δx is obtained from the value v, therefore, it is difficult to obtain information about scattering by the object. Typically, a phase considerably changes in the outline of an object. Accordingly, information about scattering by an object except its outline may fail to be obtained.

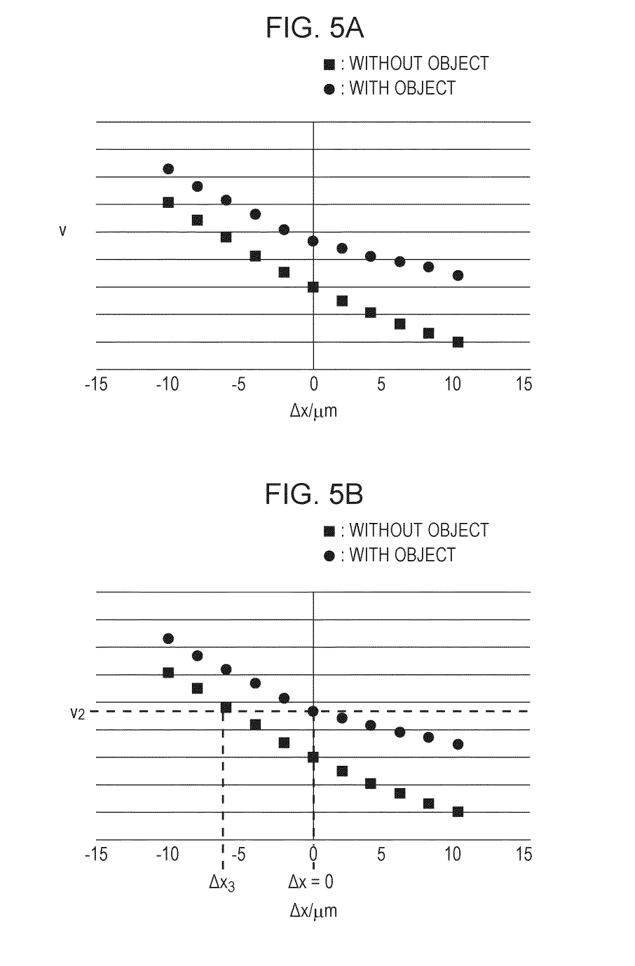

FIG. 5A illustrates a relationship between the position variation (Δx) of the X-ray beam and the value v in the case where the center of the intensity profile is offset from the boundary between the first pixel 302 and the second pixel 303 (refer to FIG. 3B). In FIG. 5A, a plot indicated by solid squares represents a data set obtained while the object was not disposed in the optical path and a plot indicated by solid circles represents a data set obtained while the object was disposed in the optical path.

Referring to FIG. 5A, these plots each represent a non-linear relationship and do not intersect each other when Δx=0. This manner of applying the X-ray beam enables the plot indicated by the solid squares and the plot indicated by the solid circles to have different values v if there is no refraction of the X-ray beam. For example, when Δx=0, therefore, information about scattering by the object can be effectively obtained.

More specific description will be made with reference to FIG. 5B. It should be that v=v₂ when there is no refraction of the X-ray beam by the object (Δx=0).

If the value v=v₂ is obtained, however, the position variation Δx obtained using the data set (indicated by the solid squares) obtained while the object was not disposed in the optical path is equal to Δx₃.

Specifically, although a true position variation (Δx) of the X-ray beam passed through a certain area (in which no phase contrast is formed because of no refraction) is essentially equal to 0, the position variation Δx=Δx₃ in the case where the position variation of the X-ray beam is obtained using the data set obtained without the object. In imaging such information, some contrast is formed in the area where the position variation of the X-ray beam passed through the object is zero. Since there is no position variation of the X-ray beam caused by refraction, this contrast corresponds to a contrast between an area with scattering and an area with no scattering (that is, such an image is obtained by imaging information about scattering by the object).

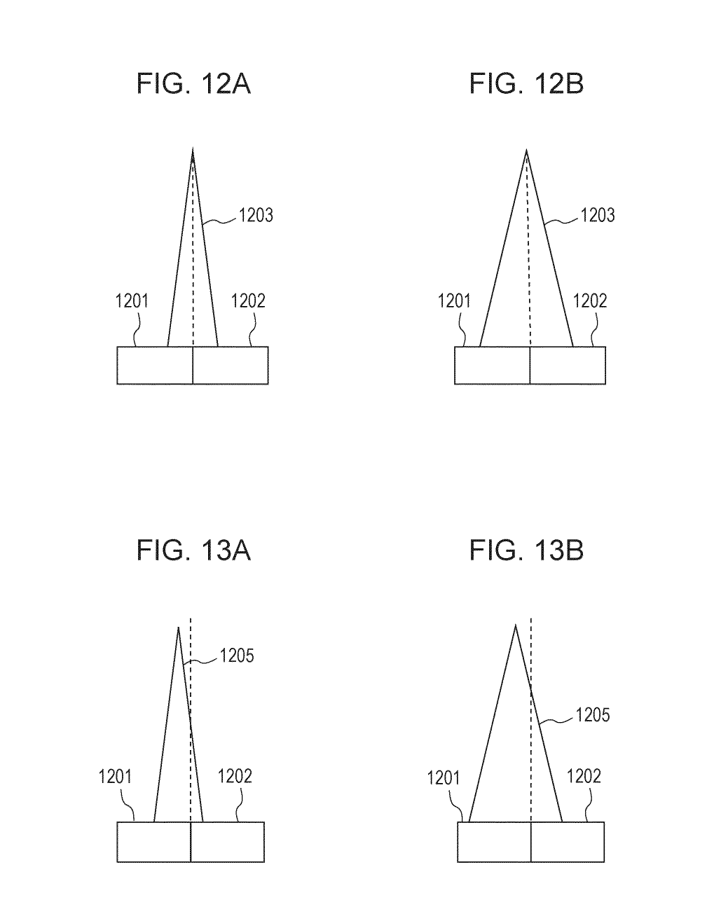

FIGS. 12A and 12B are diagrams explaining the above-described relationships from another point of view. It is assumed that an object does not refract X-rays but scatter X-rays.

FIG. 12A illustrates an intensity profile 1203 of an X-ray beam before measurement. The center of the intensity profile is set so as to coincide with a boundary between a first pixel 1201 and a second pixel 1202. FIG. 12B illustrates the intensity profile 1203 of the X-ray beam (during measurement on the object) obtained while the object was disposed in an optical path between an X-ray source and a detector, the center of the intensity profile being set so as to coincide with the boundary between the first pixel 1201 and the second pixel 1202 in the same way as in FIG. 12A. These intensity profiles are normalized to integrated intensity. In comparison between the profiles in FIGS. 12A and 12B, the center of gravity of the intensity profile was not shifted in the case where the object was disposed in the optical path and the intensity profile broadened. In this case, the difference (or ratio) between a detected intensity in the first pixel 1201 and that in the second pixel 1202 in FIG. 12A is the same value as that in FIG. 12B.

FIG. 13A illustrates an intensity profile 1205 before measurement, the center of the intensity profile being set to a position other than the boundary between the first pixel 1201 and the second pixel 1202. FIG. 13B illustrates the intensity profile 1205 (during measurement on the object) while the object was disposed in the optical path, the center of the intensity profile being set to the position illustrated in FIG. 13A. These intensity profiles are normalized to integrated intensity. In comparison between the profiles in FIGS. 13A and 13B, the difference between a detected intensity in the first pixel 1201 and that in the second pixel 1202 in FIG. 13A differs from that in FIG. 13B. Specifically, offsetting the center of the intensity profile enables acquisition of scattering information if there is no refraction. The difference between the detected intensity in the first pixel 1201 and that in the second pixel 1202 corresponds to the value v₂ in FIG. 5B. The value v₂ is temporarily replaced with the value Δx and display is performed using the value Δx as a pixel value, so that the degree of scattering can be visualized and a scattering-contrast image can be obtained.

In FIGS. 12A and 12B and FIGS. 13A and 13B, it is assumed that the object does not refract X-rays. If refraction occurs, the position of the intensity profile 1205 of FIG. 13B is further shifted. This causes the difference (or ratio) between the detected intensity in the first pixel 1201 and that in the second pixel 1202 to be changed. One of indicators indicating the magnitude of change is the value v. The value v can be replaced with the value Δx.

As described above, the use of the difference in variation between the X-ray intensity detected in the first pixel and that in the second pixel enables acquisition of object information including information about refraction of X-rays by the object and information about scattering of X-rays by the object. If the object information is imaged, an image including a phase contrast based on refraction of X-rays by the object and a scattering contrast based on scattering of X-rays by the object can be formed. Specifically, if an object hardly refracts X-rays, the value Δx obtained using the relationship between the value v and the position variation (Δx) of an X-ray beam includes information about scattering of X-rays by the object. On the other hand, if the object refracts X-rays, the value Δx obtained in the same manner includes information about refraction of X-rays by the object and information about scattering of X-rays by the object.

Although the value v may be output as an image contrast, a phase change contrast is distorted because the relationship between the value v and the value Δx is nonlinear. The arithmetic unit 106 therefore fits the relationship between the value v and the value Δx to a proper function. The arithmetic unit 106 calculates the value v from intensities in the pixels detected by the detector 105 and substitutes the value v into the function to obtain the value Δx. If imaging based on the value Δx is performed, contrast distortion can be reduced.

### Modification

In the first embodiment, a pixel value of an output image is obtained from the value v, serving as an indicator given by Expression (1). It is important that any indicator, other than the value v, can be used so long as the indicator enables determination of the difference in variation, caused by refraction or scattering, between a detected intensity in the first pixel and that in the second pixel.

In other words, any indicator based on the difference or ratio between the detected intensity in the first pixel and that in the second pixel can be used.

For example, in Expression (1), the difference between the intensities I₁ and I₂ is divided by the sum of the intensities I₁ and I₂. This indicator is based on the difference between the detected intensity in the first pixel and that in the second pixel. Accordingly, for example, an indicator (I₁−I₂)² may be used instead of the indicator (I₁−I₂) given by Expression (1).

Similarly, an indicator based on the ratio between the detected intensity in the first pixel and that in the second pixel may be used. For example, a pixel value of an output image may be determined using a value v′ given by Expression (2).

$$\begin{matrix}[ Math . 2 ] & \\ {v}^{′} = \frac{{I}_{1}}{{I}_{2}} & ( 2 )\end{matrix}$$

In the above description, a pixel value of an output image is determined using the value v or v′ calculated from measurements obtained while the object is disposed in the optical path of the X-ray beam. A pixel value may be determined using, for example, an indicator obtained by subtracting the value v obtained without the object from the value v obtained with the object. In other words, a pixel value may be determined on the basis of an indicator H given by Expression (3).

H=(I₁−I₂)/(I₁+I₂)−(I₁₍₀₎−I₂₍₀₎)/(I₁₍₀₎+I₂₍₀₎) (3)

In Expression (3), I₁₍₀₎) denotes a detected intensity in the first pixel obtained without the object and I₂₍₀₎ denotes a detected intensity in the second pixel obtained without the object. The indicator given by Expression (3) is based on the difference between the detected intensity in the first pixel and that in the second pixel.

Furthermore, a database of the relationship between the values v and Δx may be made instead of the function. The value Δx may be obtained by interpolation using data in the database on the basis of the value v obtained by measurement.

To obtain an absorption-contrast image of an object, the sum of the intensities I₁ and I₂ may be used as a pixel value. Alternatively, a mean value obtained by dividing the sum of the intensities I₁ and I₂ by two may be used as a pixel value. Operations including other arithmetic operations related to the sum may be expressed as “being based on the sum”.

Furthermore, if the aperture is a pinhole, a configuration in which irradiation is performed such that the center of the X-ray beam intensity profile is offset from the boundary of four pixels can be used. Consequently, scattering information can be obtained in a direction different from the direction (X direction) of the position variation Δx. A state of scattering at least in a direction orthogonal to the X direction can be imaged. In other words, this embodiment can be applied to a case where three or more pixels are used.

Although the center of the X-ray beam intensity profile is offset from the boundary between the first and second pixels, an offset may lie in the range of ¼ of the half width of the intensity profile to ¾ thereof. Although a suitable offset varies depending on object, the offset is, for example, approximately ½ of the half width.

### Second Embodiment

A second embodiment relates to an X-ray apparatus in which a plurality of X-ray beams are formed using a splitting element and a method for measuring X-rays in this apparatus.

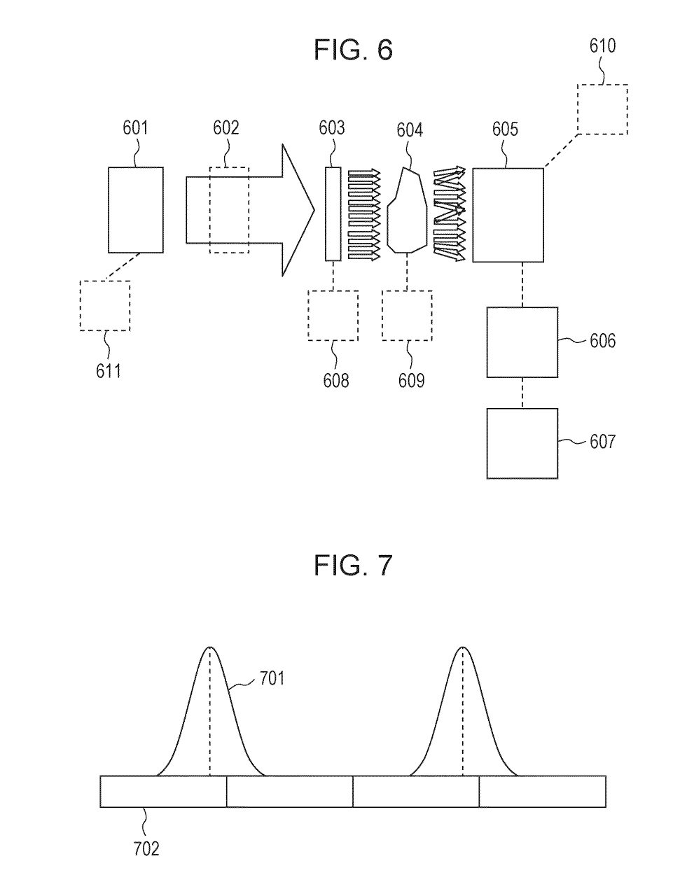

FIG. 6 illustrates a configuration of the X-ray apparatus according to the second embodiment. X-rays emitted from an X-ray source 601, serving as an X-ray generator, are separated into a plurality of X-ray beams by a splitting element 603. The splitting element 603 has, for example, a slit array having a line-and-space pattern. The splitting element 603 may have two-dimensional slits which are divided in a direction perpendicular to a direction in which the slits are arranged at regular intervals or a pinhole array (two-dimensional array of circular openings). In the case of the pinhole array, scattering information at least in two directions can be obtained.

The slits or pinholes may extend through the splitting element 603 or do not have to extend therethrough. If the slits or pinholes do not extend through the splitting element 603, a filter material for X-rays may be used for the splitting element 603. A material for the splitting element 603 may be selected from, for example, Pt, Au, Pb, Ta, and W which exhibit high X-ray absorptance. Alternatively, the material may be a compound containing these materials.

The X-ray beams passed through an object 604 are applied to a detector 605. The detector 605 detects intensities of the X-ray beams. Information about the X-ray beams obtained by the detector 605 is subjected to arithmetical processing by an arithmetic unit 606. The resultant data is output to a display unit 607, such as a monitor.

Moving units, such as stepping motors, 608, 609, 610, and 611 configured to move the splitting element 603, the object 604, the detector 605, and the X-ray source 601 relative to one another, respectively, may be provided separately. For example, the moving unit 609 can appropriately move the object 604, so that an image of a specific portion of the object 604 can be obtained. Furthermore, since the splitting element 603 allows the X-ray beams to be applied to the object 604 such that the X-ray beams are spatially separated, information about portions of the object 604 irradiated with no X-ray beams is not obtained. Measurement with scanning of X-rays over the object 604 enables acquisition of information of the whole object 604, thus achieving high resolution.

Furthermore, while the X-ray source 601, the splitting element 603, and the detector 605 are revolved around the object 604 in synchronization with one another by the moving units 608, 610, and 611, the intensities of the X-ray beams can be detected to obtain a computed tomography (CT) image.

For the detector 605, any of various two-dimensional X-ray detectors can be used regardless of the indirect conversion type or the direct conversion type. The detector 605 may be selected from, for example, an X-ray CCD camera, an indirect conversion flat panel detector, and a direct conversion flat panel detector.

If monochromatic X-rays are used, a monochromatizing unit 602 may be disposed between the X-ray source 601 and the splitting element 603. Examples of the monochromatizing unit 602 include a monochromator with slits and an X-ray multilayer mirror.

The relationship between the X-ray beams and the detector 605 in this embodiment will now be described with reference to FIG. 7. A profile 701 represents X-ray beam intensities detected by the detector 605 while the object 604 was not disposed. The detector 605 has pixels 702.

Since the X-ray beams are provided by the splitting element 603, the detector 605 and the splitting element 603 are arranged in consideration of the pitch of the slit array and the distant relationship among the X-ray source 601, the splitting element 603, and the detector 605 such that the X-ray beams are separately applied and each X-ray beam is applied so as to span two pixels. The X-ray beams are applied to the detector 605 such that the center of an intensity profile of each X-ray beam applied while the object 604 is not disposed is offset from a boundary between two pixels. An offset may lie in the range of ¼ of the half width of the intensity profile to ¾ thereof. Although a suitable offset varies depending on object, the offset is, for example, approximately ½ of the half width.

Values Δx related to the X-ray beams are obtained by the arithmetic unit 606 in a manner similar to the first embodiment. Information containing information about refraction of X-rays by the object and information about scattering of X-rays by the object can be obtained using the obtained values. Imaging based on the values Δx can form an image having a scattering contrast in addition to a phase contrast.

### Example

In an example, the configuration the apparatus of FIG. 6 was used.

The X-ray source 601 used was a tungsten-target rotating anode X-ray generator.

The splitting element 603 used was one made by forming a slit array having a slit width of 50 μm and a pitch of 125 μm on a tungsten plate having a thickness of 500 μm by electrical discharge machining.

The detector 605 used was a CdTe direct conversion flat panel detector having a pixel size of 100 μm by 100 μm.

The splitting element 603 and the detector 605 were arranged using the moving units 608 and 610 such that each of the X-ray beams separated by the splitting element 603 was applied so as to span two pixels (200 μm) on the detector 605. Furthermore, the splitting element 603 and the detector 605 were arranged such that the center of the intensity profile of each X-ray beam was offset from the boundary between two pixels by approximately 25 μm.

In the above-described arrangement, while the splitting element 603 was being moved, a detected intensity of each X-ray beam in the first pixel and that in the second pixel on the detector 605 were measured, thus obtaining the value v relative to the position variation (Δx) of the X-ray beam. The relationship between them was fitted to a quartic function, thus obtaining a function to derive the value Δx from the value v.

As regards the object 604, a plastic container of flour and a plastic container of water were used.

The value v was calculated on the basis of data indicating the intensities in the first and second pixels of each X-ray beam by the arithmetic unit 606 and the value Δx was calculated using the quartic function obtained in advance.

The sum of the intensities in the first and second pixels of each X-ray beam and the value Δx were arranged as pixel values, thereby forming images that reflected an absorption contrast and image that reflected both a phase contrast and a scattering contrast. The images were displayed on the display unit 607, such as a PC monitor.

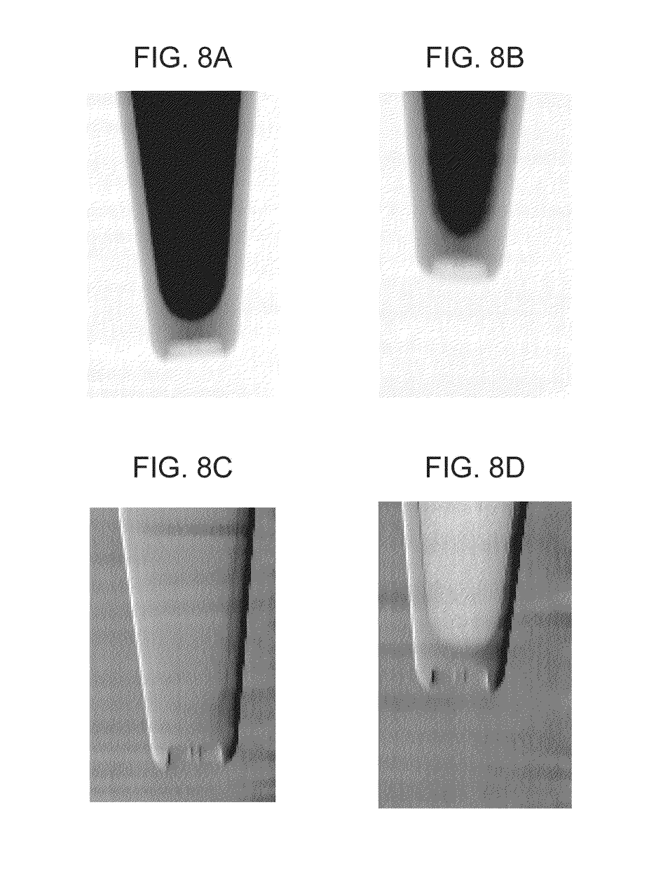

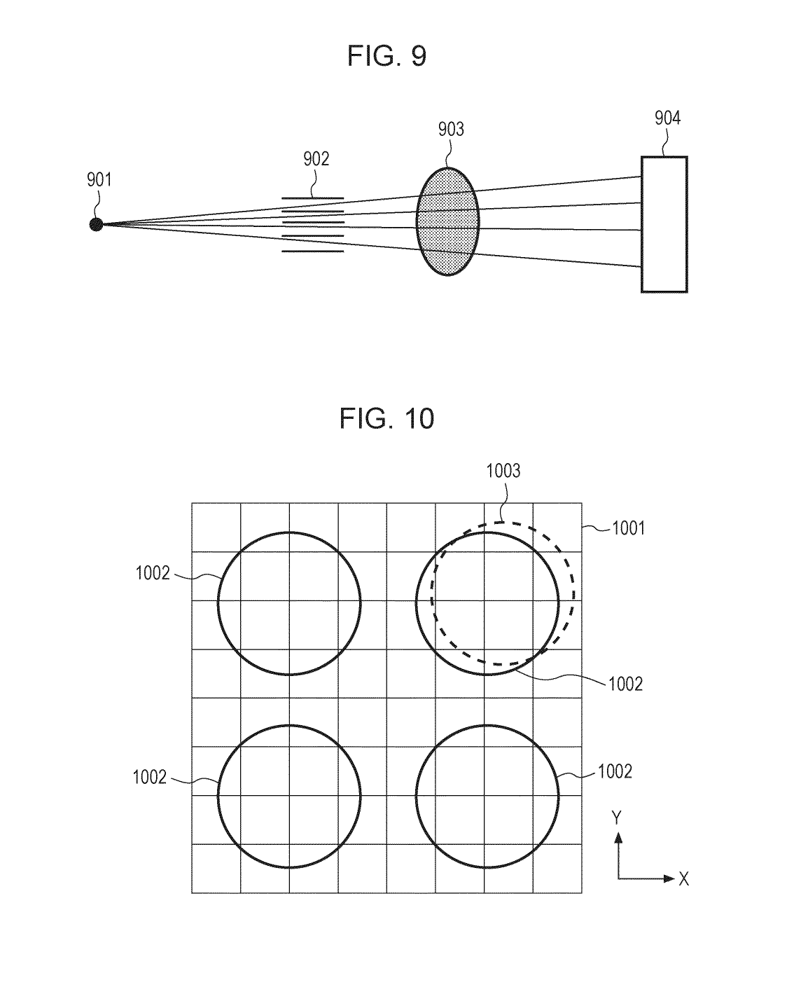

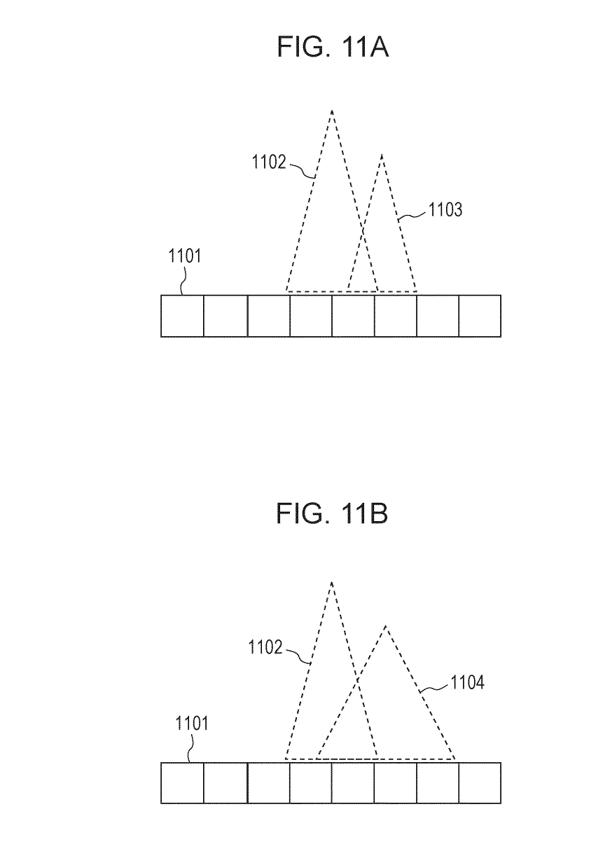

FIG. 8A illustrates an absorption-contrast image of the plastic container of water and FIG. 8B illustrates an absorption-contrast image of the plastic container of flour. As illustrated in FIGS. 8A and 8B, there is little difference in contrast between the absorption-contrast images of water and four.

FIG. 8C illustrates a phase- and scattering-contrast image of the plastic container of water and FIG. 8D illustrates a phase- and scattering-contrast image of the plastic container of flour. As illustrated in FIGS. 8C and 8D, the phase- and scattering-contrast image of flour, which exhibits high scattering, has a high contrast. Thus, the difference between water and flour can be identified.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-130102, filed Jun. 7, 2012, which is hereby incorporated by reference herein in its entirety.

### REFERENCE SIGNS LIST

101 X-ray source
103 aperture plate
104 object
105 detector
106 arithmetic unit

What is claimed is:

1. An X-ray apparatus comprising:
a detector configured to detect an intensity of at least one X-ray beam passed through an object,
wherein the detector has a first pixel and a second pixel different from the first pixel, and
wherein the apparatus is configured such that when the object is not disposed in an optical path of the X-ray beam, the center of an intensity distribution of the X-ray beam applied to the detector does not coincide with a boundary between the first and second pixels.

2. The apparatus according to claim 1, further comprising:
an arithmetic unit configured to obtain object information including information about scattering of the X-ray beam by the object using an intensity of the X-ray beam detected in the first pixel and an intensity of the X-ray beam detected in the second pixel.

3. The apparatus according to claim 2, wherein the arithmetic unit obtains the object information on the basis of an indicator that enables determination of a difference in variation between the detected intensity in the first pixel and that in the second pixel.

4. The apparatus according to claim 3, wherein the indicator is based on a difference between the detected intensity in the first pixel and that in the second pixel or a ratio between the detected intensity in the first pixel and that in the second pixel.

5. The apparatus according to claim 3, wherein the indicator is obtained from the detected intensity in the first pixel obtained while the object is not disposed in the optical path of the X-ray beam and the detected intensity in the second pixel obtained while the object is not disposed in the optical path of the X-ray beam.

6. The apparatus according to claim 3,
wherein the object information is calculated on the basis of the indicator and a function to which a relationship between the indicator and the object information is fitted.

7. The apparatus according to claim 3,
wherein the arithmetic unit includes a database indicating a relationship between the indicator and the object information, and
wherein the object information is derived from the database.

8. The apparatus according to claim 1, further comprising:
a splitting element configured to form a plurality of X-ray beams.

9. The apparatus according to claim 8, wherein the splitting element has a slit array.

10. The apparatus according to claim 8, wherein the splitting element has a pinhole array.

11. The apparatus according to claim 1,
wherein the arithmetic unit obtains information about absorption in the object using a sum of the detected intensity in the first pixel and the detected intensity in the second pixel.

12. The apparatus according to claim 1,
wherein the first pixel and the second pixel are arranged next to each other.

13. The apparatus according to claim 1,
wherein the apparatus is configured such that when the object is not disposed in the optical path of the X-ray beam, the center of the intensity distribution of the X-ray beam is offset from the boundary between the first and second pixels by a distance in a range of ¼ of a half width of the intensity distribution of the X-ray beam to ¾ thereof.

14. The apparatus according to claim 1,
wherein the object information includes a pixel value of an image having information about scattering of the X-ray beam by the object.

15. The apparatus according to claim 1,
wherein the object information includes information about scattering of the X-ray beam by the object and information about refraction of the X-ray beam by the object.

16. The apparatus according to claim 1, further comprising:
an X-ray source configured to apply X-rays to the object.

17. A method of measuring X-rays, the method comprising the steps of:
detecting an intensity of an X-ray beam passed through an object in a first pixel and that in a second pixel different from the first pixel;
obtaining object information including scattering contrast information related to the object on the basis of the detected intensity of the X-ray beam in the first pixel and that in the second pixel; and
setting such that when the object is not disposed in an optical path of the X-ray beam, a center of an intensity distribution of the X-ray beam applied does not coincide with a boundary between the first and second pixels.

18. The method according to claim 17, wherein in the obtaining step, the object information is obtained on the basis of an indicator that enables determination of a difference in variation between the detected intensity in the first pixel and that in the second pixel.
